(19) United States
(12) Patent Application Publication
(10) Pub. No.: US 2017/0353283 A1
(43) Pub. Date: Dec. 7, 2017

(54) DATA TRANSFER METHOD, WIRELESS ACCESS POINT AND COMPUTER PROGRAM PRODUCT THEREOF

(71) Applicant: PEGATRON CORPORATION, Taipei City (TW)

(72) Inventors: HSIAO-HAO HSU, Taipei City (TW); WEI-CHE HSIEH, Taipei City (TW); YI-CHANG CHEN, Taipei City (TW)

(21) Appl. No.: 15/460,823

(22) Filed: Mar. 16, 2017

(30) Foreign Application Priority Data
Jun. 7, 2016 (TW) 105117998

(51) Int. Cl. H04L 5/00; H04B 7/0452

(52) U.S. Cl. CPC H04L 5/0078; H04B 7/0452

(57) ABSTRACT

A data transfer method for a wireless access point with a Multi-User Multiple-Input Multiple-Output (MU-MIMO) function is disclosed. The data transfer method includes: receiving support function information and a data transfer request from each of electronic devices; determining whether each of the electronic devices supports MU-MIMO function according to the support function information; dividing the electronic devices into a first group supporting the MU-MIMO function and a second group without supporting the MU-MIMO function; allocating a first transferring time frame to the first group and allocating a second transferring time frame to the second group according to the data transfer requests; transferring data requested by the first group within the first transferring time frame via the MU-MIMO function; transferring data requested by the second group within the second transferring time frame.

### CROSS-REFERENCE TO RELATED APPLICATION

This application claims the priority benefit of Taiwan application serial no. 105117998, filed on Jun. 7, 2016. The entirety of the above-mentioned patent application is hereby incorporated by reference herein and made a part of this specification.

### BACKGROUND

### Technology Field

The disclosure relates to a data transfer method and, more particularly, to a relatively high speed data transfer method among a wireless access point and multiple electronic devices supporting a Multi-User Multiple-Input Multiple-Output (MU-MIMO) function.

### Description of the Related Art

Accessing the Internet with electronic devices such as computers or mobile phones has become an important activity for people's daily lives. In addition to use of the phone's 3G or 4G features, when a user is connecting to the Internet, the user often has his electronic device connected to a Wi-Fi network set up by a wireless access point in a user specific area for a better connection to the Internet for webpage browsing or online video watching. A conventional wireless access point usually supports a Single-User Multiple-Input Multiple-Output (SU-MIMO) function and the wireless access point with SU-MIMO performs data transfer with electronic devices once at a time. Therefore, as shown in FIG. 1, when three electronic devices SU1, SU2, SU3 supporting SU-MIMO intend to connect to the Internet via the wireless access point, the wireless access point will arrange the three electronic devices SU1, SU2, SU3 in a queue, and perform data transfer with the three electronic devices SU1, SU2, SU3 one by one. The wireless access point transfers data to the electronic device SU1 within a first time frame T1 first, then transfers data to the electronic device SU2 within a second time frame T2 and lastly transfers data to the electronic device SU3 within a third time frame T3. If too many electronic devices intend to access to the Internet via the wireless access point with support of SU-MIMO, the waiting time for each electronic device for data transmission will be considerably increased.

Hence, the users of the electronic devices may lose their patience because of the long waiting time.

The MU-MIMO function allows a wireless access point with support of MU-MIMO to transfer data to multiple electronic devices simultaneously. If three electronic devices supporting MU-MIMO intend to access to the Internet at the same time through the MU-MIMO wireless access point, the MU-MIMO wireless access point will allocate respective time frames for these three electronic devices for simultaneous data transfer. In this situation, the users of the MU-MIMO electronic devices can have their devices access to the Internet without a long waiting.

A conventional electronic device which supports SU-MIMO only, however, is unable to receive data transmitted from the MU-MIMO wireless access point. If a MU-MIMO wireless access point detects the electronic device supporting SU-MIMO only around, the MU-MIMO wireless access point will disable the MU-MIMO function and switch to the SU-MIMO mode to be ready for the data transfer with the SU-MIMO only electronic device. The MU-MIMO wireless access point won't switch back to MU-MIMO until the SU-MIMO only electronic device leaves the coverage of the MU-MIMO wireless access point. Therefore, even if the wireless access point supports the MU-MIMO function, the MU-MIMO wireless access point will still have to switch to SU-MIMO, and perform data transfer with all electronic devices via SU-MIMO, which degrades the efficiency.

### SUMMARY

The present invention provides a data transfer method, a wireless access point and a computer program product to prevent the wireless access point from switching back to a conventional SU-MIMO function when some electronic devices do not support MU-MIMO.

The present invention provides a data transfer method applied to a wireless access point with support of MU-MIMO and multiple electronic devices. The data transfer method includes: receiving support function information and a data transfer request from each of the electronic devices; according to the support function information, determining whether each of the electronic devices supports MU-MIMO function; dividing the electronic devices into a first group supporting the MU-MIMO function and a second group without supporting the MU-MIMO function; allocating a first transferring time frame to the first group and allocating a second transferring time frame to the second group according to the data transfer requests; transferring data requested by the first group within the first transferring time frame via the MU-MIMO function; transferring data requested by the second group within the second transferring time frame.

The present invention further provides a wireless access point for transferring data to a plurality of electronic devices. At least one of the electronic devices supports a MU-MIMO function. The wireless access point includes a transceiver, a controller and a MU-MIMO module. The transceiver receives support function information and a data transfer request from each of the electronic devices. The controller is coupled to the transceiver for determining whether each of the electronic devices supports the MU-MIMO function according to the support function information, and dividing the electronic devices into a first group and a second group according to a determination result. The first group includes at least one electronic device supporting the MU-MIMO function and the second group includes at least one electronic device without supporting the MU-MIMO function. The controller is further used for allocating a first transferring time frame for the at least one electronic device in the first group and allocating a second transferring time frame for the other electronic devices in the second group. The MU-MIMO module is coupled to the controller. When the transceiver receives the support function information and the data transfer request from each electronic device, the controller controls the operation of the MU-MIMO module to transfer the data requested by the first group within the first transferring time frame. The controller also controls the transceiver to transfer the data requested by the second group within the second transferring time frame.

The present invention further provides a computer program product to fulfill the abovementioned data transfer method after the computer program product of the present invention is installed and executed in a wireless access point.

These and other features, aspects, and advantages of the present invention will become better understood with regard to the following description, appended claims, and accompanying drawings.

### BRIEF DESCRIPTION OF THE DRAWINGS

FIG. 1 illustrates a relationship between a transferring capacity and time among a wireless access point and the electronic devices supporting a SU-MIMO function in the prior art.

FIG. 2 is a schematic diagram of a wireless access point and multiple electronic devices according to an embodiment of the present invention.

FIG. 3 illustrates a system structure of a wireless access point and multiple electronic devices according to an embodiment of the present invention.

FIG. 4 is a flow chart of a first part of a data transfer method according to an embodiment of the present invention.

FIG. 5 is a flow chart of a second part of the data transfer method in FIG. 4.

FIG. 6 illustrates a relationship between a transferring capacity and time among a wireless access point and multiple electronic devices according to an embodiment of the present invention.

FIG. 7 illustrates a relationship between a transferring capacity and time among a wireless access point and multiple electronic devices according to another embodiment of the present invention.

### DETAILED DESCRIPTION

For a better understanding of the technical aspects of the present invention for an examiner, preferred embodiments of the present invention are described below.

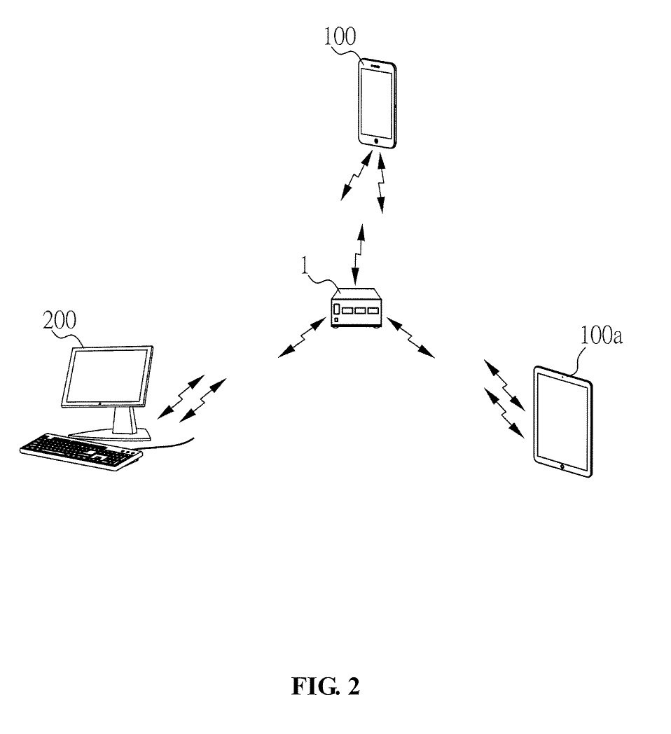

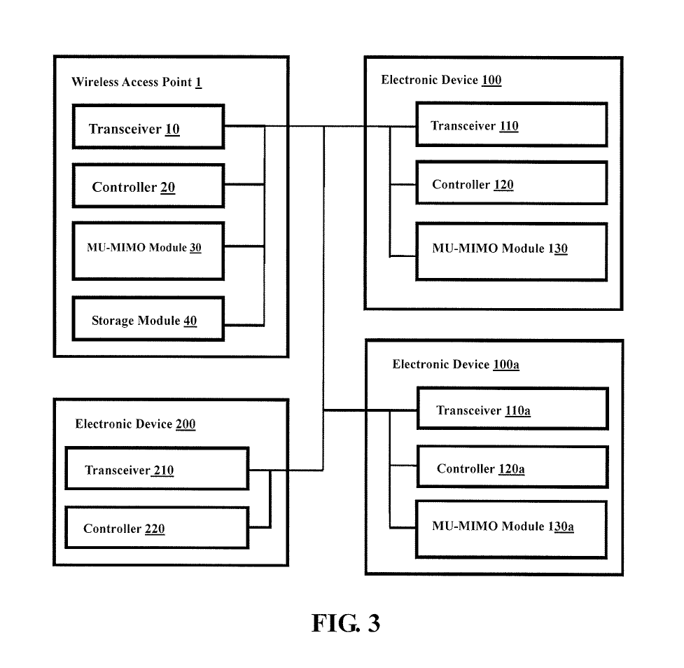

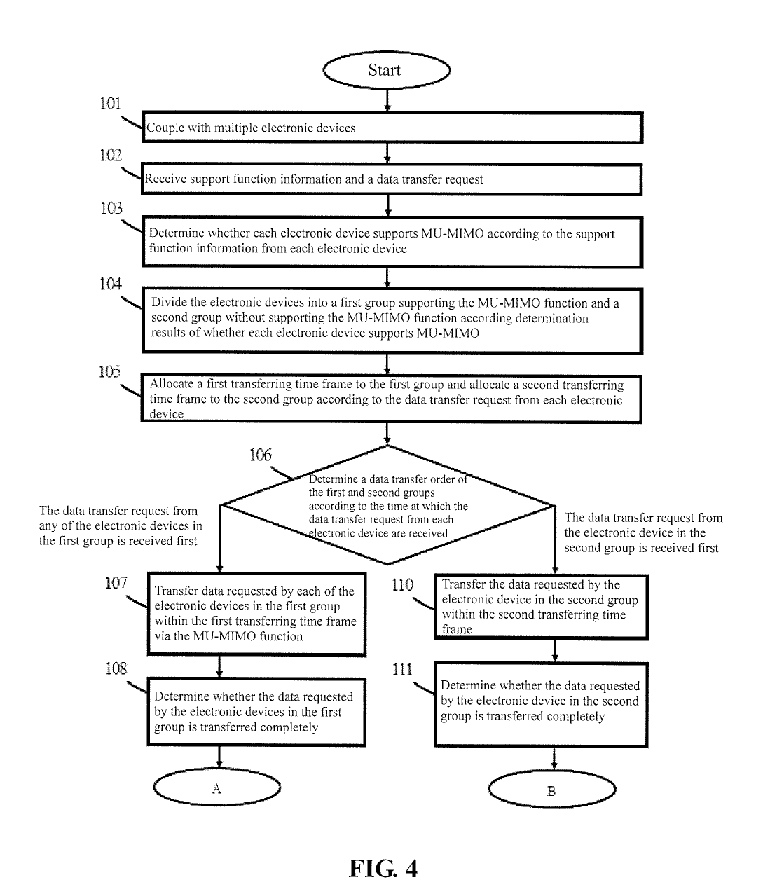

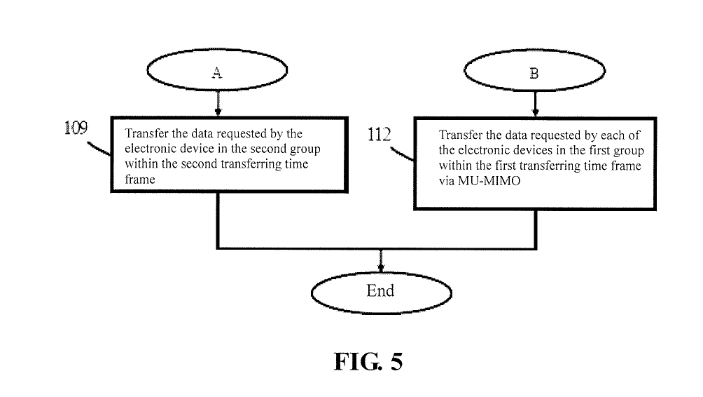

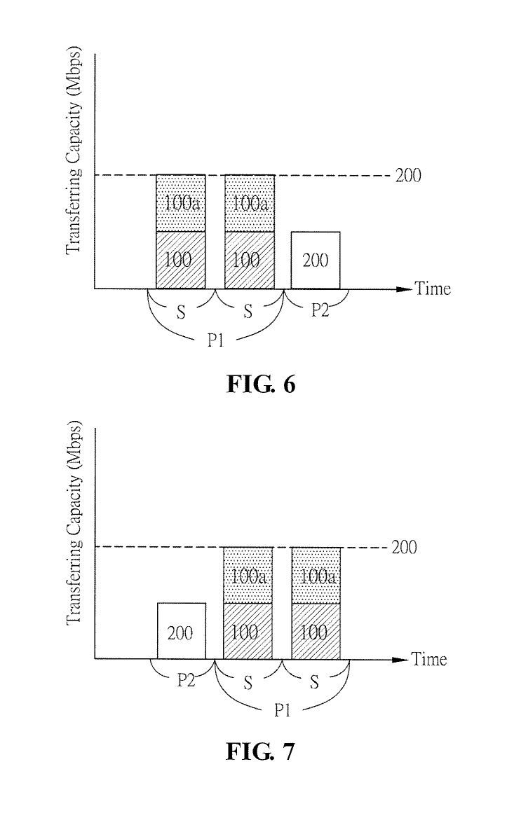

Please cross-refer to the following FIGS. 2-7, regarding a data transfer method, a wireless access point and a computer program product of the present invention. FIG. 2 is a schematic diagram of a wireless access point and multiple electronic devices according to an embodiment of the present invention. FIG. 3 is a system structure of a wireless access point and multiple electronic devices according to an embodiment of the present invention. FIG. 4 is a flow chart of a first part of a data transfer method according to an embodiment of the present invention. FIG. 5 is a flow chart of a second part of the data transfer method. FIG. 6 illustrates a relationship between a transferring capacity and time between a wireless access point and electronic devices according to an embodiment of the present invention. FIG. 7 illustrates a relationship between a transferring capacity and time between a wireless access point and electronic devices according to another embodiment of the present invention.

As shown in FIGS. 2, 5 and 6, according to an embodiment of the present invention, the data transfer method can be compiled into a computer program product and the computer program product can be stored in a wireless access point 1 supporting MU-MIMO. The computer product for the data transfer method of the present invention allows the wireless access point 1 to maintain relatively good transfer efficiency when transferring data with electronic devices 100 and 100a supporting MU-MIMO and an electronic device 200 without supporting MU-MIMO. The electronic devices 100 and 100a supporting MU-MIMO of the present invention are a smart phones and a tablet, respectively, but could be any other electronic devices with a network function, for example a smart watch and a computer. The electronic device 100 includes a transceiver 110, a controller 120 and a MU-MIMO module 130. The transceiver 110 is coupled to an external network for data transfer. The controller 120 is coupled to the transceivers 110 and the MU-MIMO module 130 for controlling the operation of the transceivers 110 and the MU-MIMO module 130. The MU-MIMO module 130 of the electronic device 100 could be hardware, software or firmware or a combination of hardware, software or firmware providing the MU-MIMO function. When the MU-MIMO module 130 operates, it allows the transceiver 110 to perform fast data transfer via MU-MIMO. The electronic device 100a includes the same components as the electronic device 100 does, and therefore the detailed description is omitted herein.

The electronic device 200 without supporting MU-MIMO of the present invention is a computer, but could be any electronic device with the network function, for example a smart phone, a smart watch or a tablet. The electronic device 200 includes a transceiver 210 and a controller 220. The transceiver 210 is coupled to an external network for data transfer. The controller 220 is coupled to the transceiver 110 for controlling the operation of the transceiver 210. Since the electronic device 200 does not include a MU-MIMO module, the electronic device 200 only supports a conventional SU-MIMO function.

In an embodiment of the present invention, the wireless access point 1 is coupled with the three electronic devices 100, 100a and 200 for data transfer. However, the number of the electronic devices can be increased or decreased according to actual requirements and is not limited to three. The wireless access point 1 includes a transceiver 10, a controller 20, a MU-MIMO module 30, and a storage module 40. The transceiver 10 is coupled to the external network and the electronic devices 100, 100a and 200 for data transfer and receives support function information and a data transfer request from each of the electronic devices 100, 100a and 200.

The controller 20 can be, for example, a central process unit (CPU). The controller 20 is coupled to the transceiver 10, the MU-MIMO module 30 and the storage module 40 for controlling the operation of the transceiver 10, the MU-MIMO module 30 and the storage 30. The controller 20 determines whether each of the electronic devices 100, 100a and 200 supports the MU-MIMO function according to the support function information and the data transfer request sent from each of the electronic devices 100, 100a and 200. And the controller 20 divides the electronic devices 100, 100a and 200 into a first group and a second group according to a determination result. The first group includes the electronic devices 100 and 100a which support the MU-MIMO function. The second group includes the electronic device 200 which does not support the MU-MIMO function. The controller 20 further allocates a first transferring time frame P1 to the electronic devices 100 and 100a in the first group and allocates a second transferring time frame P2 to the electronic device 200 in the second group and switches between the first time frame P1 and the second time frame P2. Moreover, the controller 20 determines a data transfer order of the first group and the second group and controls the operation of the MU-MIMO module 30 in collaboration with the transceiver 10 to transfer data to the electronic devices 100 and 100a in the first group within the first transferring time frame P1, and controls the transceiver 10 to transfer data to the electronic device 200 in the second group within the transferring time frame P2. The controller 20 further determines whether the data requested by the first group and the second group is transferred completely.

The MU-MIMO module 30 is hardware, software, firmware or a combination of hardware, software and firmware, providing the MU-MIMO function. When the MU-MIMO module 30 operates, it allows the transceiver 10 to perform fast data transfer via MU-MIMO. The storage module 40, for example, is a memory for storing the computer program product for the data transfer method of the present invention and for storing the data required by the computer program product.

As shown in FIGS. 3-5, in one embodiment of the present invention, when the wireless access point 1 installs and executes the computer program product the following data transfer method will be performed. Firstly, Step 101 is performed: Couple with multiple electronic devices.

As shown in FIG. 2 and FIG. 3, in an embodiment of the present invention, the wireless access point 1 starts searching to make sure whether there is any electronic devices 100, 100a and 200 in the coverage of the wireless access point 1 and establishes an electrical coupling with the electronic devices 100, 100a and 200 according to a wireless network setup.

Then, Step 102 is performed: Receive support function information and a data transfer request from each of the electronic devices 100, 100a and 200.

In an embodiment of the present invention, each of the electronic devices 100, 100a and 200 sends the support function information and the data transfer request to the transceiver 10 of the wireless access point 1 when multiple users are accessing the Internet with the electronic devices 100, 100a and 200. The support function information is used for informing the wireless access point 1 whether the electronic device supports MU-MIMO. The data transfer request is used for informing the wireless access point 1 that the electronic device needs to take specific actions so it is necessary for the electronic device to download specific data from the external network (for example, when the electronic device intends to connect to a specific website, the electronic device has to download data from a server of the website; or when the electronic device intends to play an online video, the electronic device needs to download the online video from a server in which the online video is stored). In this embodiment, the electronic devices 100 and 100a support the MU-MIMO function and thus the controllers 120 and 120a of the electronic devices 100 and 100a would control the transceivers 110 and 110a to transmit the support function information with support of the MU-MIMO function to the wireless access point 1. Since the electronic device 20 does not support the MU-MIMO function the controller 120 of the electronic device 200 transmits the support function information without support of the MU-MIMO function to the wireless access point 1. Furthermore, the electronic devices 100, 100a and 200 individually transmit the data transfer requests of the electronic devices 100, 100a and 200 to the wireless access point 1 through the transceivers 110, 110a and 210.

Then, Step 103 is performed: Determine whether each electronic device supports MU-MIMO according to the support function information from each electronic device.

In one embodiment of the present invention, when the transceiver 10 of the wireless access point 1 receives the support function information from each of the electronic devices 100, 100a and 200, the transceiver 10 sends the support function information to the controller 20. The controller 20 determines that the electronic devices 100 and 100a support the MU-MIMO function according to the support function information sent from the electronic devices 100 and 100a. On the other hand, the controller 20 determines that the electronic device 200 does not support the MU-MIMO function according to the support function information sent from the electronic device 200.

Then, Step 104 is performed: Divide the electronic devices into a first group supporting the MU-MIMO function and a second group without supporting the MU-MIMO function according determination results of whether each electronic device supports MU-MIMO.

After determining whether the MU-MIMO function is supported, the controller 20 divides the electronic devices 100, 100a and 200 into the first group and the second group. The electronic devices 100 and 100a which support the MU-MIMO function are in the first group while the electronic device 200 which does not support the MU-MIMO function is in the second group.

Then, Step 105 is performed: Allocate a first transferring time frame to the first group and allocate a second transferring time frame to the second group according to the data transfer request from each electronic device.

As shown in FIGS. 2, 3 and 6, the transceiver 10 connects to the server of the external network according to a content (e.g. a particular website in the interest of browsing) of the data transfer requests after the transceiver 10 of the wireless access point 1 receives the data transfer request from each of the electronic devices 100, 100a and 200. The server of the particular website of the external network transmits data packets back to the transceiver 10 to inform the wireless access point 1 that the respective data volumes should be transferred to each of the electronic devices 100. 100a and 200 to meet their data transfer requests. And thereby, the controller 20 calculates the first transferring time frame P1 within which the data requested by the electronic devices 100 and 100a in the first group is completely transferred from the server of the particular website through the wireless access point 1 and calculates the second transferring time frame P2 within which the data requested by the electronic device 200 in the second group is completely transferred from the server of the particular website through the wireless access point 1, according to the data transfer requests and the data packets sent back from the server of the particular website. The transferring time frame P1 could include two first time transferring time slots S, but the number of the first transferring time slots is not limited herein. The number of the first transferring time slots could vary with the size of the data requested by the electronic devices 100 and 100a in the first group.

Then, Step 106 is performed: Determine a data transfer order of the first group and the second group according to the time at which the data transfer request from each electronic device are received.

In one embodiment of the present invention, the controller 20 determines the data transfer order of the first and the second groups according to the time at which the data transfer requests from the electronic devices are received. If the data transfer request from any of the electronic devices 100 and 100a in the first group is received before the data transfer request from the electronic device 200 in the second group, then Step 107 is performed and the first group is set as the first priority for data transfer. If the data request from the electronic device 200 in the second group is received before the data requests from the electronic devices 100 and 100a in the first group, then Step 111 is performed and the second group is set as the first priority for data transfer. However, the criterion that the controller 20 uses to determine the data transfer order of the first and the second groups is not limited to the time when the data transfer requests are received. The data transfer order could be determined by user's requirements, for example, the data volumes transmitted to each of the electronic devices 100, 100a and 200 could be a criterion for the data transfer order. For example, small files with the sizes less than a certain level can be transferred first.

If the electronic devices 100 and 100a send the data transfer requests to the transceiver 10 of the wireless access point 1 before the electronic device 200, then Step 107 is performed: Transfer data requested by each of the electronic devices in the first group within the first transferring time frame via the MU-MIMO function.

As shown in FIG. 3 and FIG. 6, the controller 20 controls the transceiver 10 to receive the data individually requested by the electronic devices 100 and 100a from the external network, and the controller 20 controls the operation of the MU-MIMO module 30 to allow the transceiver 10, via MU-MIMO, to rapidly and simultaneously transfer the requested data to the transceivers 110 and 110a of the electronic devices 100 and 100a within the first transferring time slots of the first transferring time frame P1.

Then, Step 108 is performed: Determine whether the data requested by the electronic devices in the first group is transferred completely. If so, switch to the second transferring time frame.

The controller 20 determines whether the transceiver 10 completely transfers the data requested by the electronic devices 100 and 100a to the transceivers 110 and 110a of the electronic devices 100 and 100a. If so, the controller 20 controls the MU-MIMO module 30 to stop and turns off the first transferring time frame P1 and begins the second transferring time frame P2. If the controller 20 has not finished transferring, the controller 20 can increase the first transferring time slots S accordingly to prolong the first transferring time frame P1 and finish transferring the data requested by the electronic devices 100 and 100a.

Lastly, Step 109 is performed: Transfer the data requested by the electronic device in the second group within the second transferring time frame.

The controller 20 begins the second transferring time frame P2 and controls the transceiver 10 to receive the data requested by the electronic device 220 from the external network. The controller 20 controls the transceiver 10 to completely transfer the requested data to the transceiver 210 of the electronic device 200 in the second group within the second transferring time frame P2.

Go back to Step 106 to determine the data transfer order of the first group and the second group. If the electronic device 200 sends the data transfer request to the transceiver 10 of the wireless access point I before the electronic devices 100 and 100a, then Step 110 is performed: Transfer the data requested by the electronic device in the second group within the second transferring time frame.

As shown in FIG. 3 and FIG. 7, in one embodiment of the present invention, the controller 20 determines that the data needs to be transferred to the electronic device 200 first so the controller 20 controls the transceiver 10 to receive the data requested by the electronic device 200 from the external network as well as controls the transceiver 10 to completely transfer the request data to the transceiver 210 of the electronic device 200 in the second group within the transferring time frame P2.

Then, Step 111 is performed to determine whether the data requested by the electronic device in the second group is transferred completely. Step 111 is similar to Step 108. If the controller 20 determines that the data transfer has not yet finished, the controller 20 can adjust the second transferring time frame P2 to prolong the second transferring time frame P2 accordingly for the completion of the data transfer for the electron device 200 in the second group. If the data transfer is complete, then the second transferring time frame P2 is turned off and the first transferring time frame P1 begins.

Lastly, Step 112 is performed: Transfer the data requested by each of the electronic devices 100 and 100a in the first group within the first transferring time frame via MU-MIMO. Step of the transceiver 10 transferring the data requested by the electronic devices 100 and 100a is similar to the aforementioned Step 108, thus the description is omitted herein.

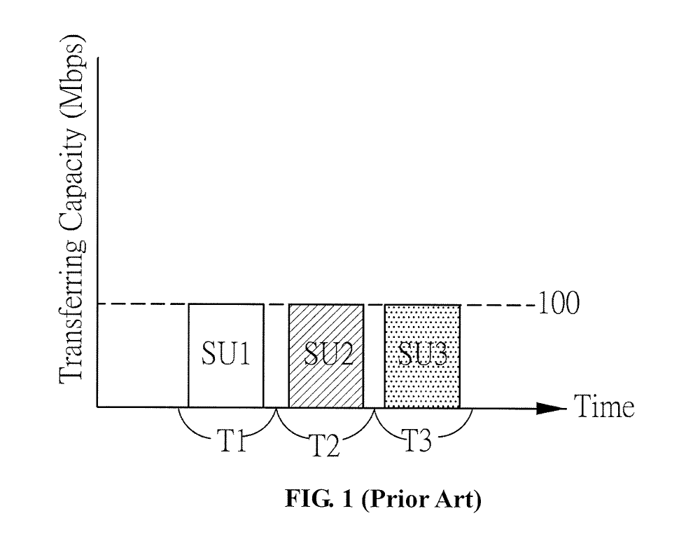

As described above, according to the computer program product of the data transfer method of the present invention, the wireless access point 1 does not have to disable the MU-MIMO function nor does it switch back to the conventional SU-MIMO function when there is an electronic device without supporting the MU-MIMO function in the coverage of the wireless access point 1. The wireless access point 1 can automatically determine whether to enable the MU-MIMO function and automatically segment the transferring time into the respective transferring time frames for MU-MIMO and SU-MIMO in order to successfully transfer the data requested by the electronic devices 100 and 100a via the MU-MIMO function as well as transfer the data requested by the electronic device 200 via the SU-MIMO function. Since the wireless access point 1 of the present invention combines the conventional data transfer method with the MU-MIMO data transfer method to perform data transfer on the electronic devices 100, 100a and 200, the wireless access point 1 of the present invention still remains a good transferring rate of MU-MIMO when performing data transfer via MU-MIMO (as shown in FIG. 6, the transferring rate can still reach 200 Mbps in the transferring slots S of the transferring time frame P1, which is twice as much as the conventional method via SU-MIMO in FIG. 1 and therefore over all transferring rate for the wireless access point 1 stays relatively fast and efficient).

It is noted that the embodiments disclosed above are for illustrative purposes only and not limited herein. Various modifications and alterations might be made by those skilled in the art without departing from the spirit and scope of the invention as set forth in the following claims.

What is claimed is:

1. A data transfer method for a wireless access point and a plurality of electronic devices, the wireless access point supporting a Multi-User Multiple-Input Multiple-Output (MU-MIMO) function, the data transfer method comprising:
receiving support function information and a data transfer request from each of the electronic devices;
determining whether each of the electronic devices supports the MU-MIMO function according to the support function information;
dividing the electronic devices into a first group supporting the MU-MIMO function and a second group without supporting the MU-MIMO function;
allocating a first transferring time frame to the first group and allocating a second transferring time frame to the second group according to the data transfer requests;
transferring data requested by the first group within the first transferring time frame via the MU-MIMO function; and
transferring data requested by the second group within the second transferring time frame.

2. The data transfer method of claim 1, wherein the first transferring time frame comprises at least one first transferring time slot.

3. The data transfer method of claim 2 further comprising: determining a data transfer order of the first group and the second group.

4. The data transfer method of claim 3, wherein determining the data transfer order of the first group and the second group further comprises:
determining the data transfer order of the first group and the second group according to the time at which the data transfer request from each of the electronic devices is received.

5. The data transfer method of claim 4 further comprising: determining whether the data requested by the first group is transferred completely, if so, switching to the second transferring time frame.

6. The data transfer method of claim 4 further comprising: determining whether the data requested by the second group is transferred completely, if so, switching to the first transferring time frame.

7. A wireless access point for transferring data with a plurality of electronic devices, wherein at least one of the electronic devices supports a MU-MIMO function, the wireless access point comprising:
a transceiver for receiving support function information and a data transfer request from each of the electronic devices;
a controller coupled to the transceiver, for determining whether each of the electronic devices supports the MU-MIMO function according to the support function information, dividing the electronic devices into a first group supporting the MU-MIMO function and a second group without supporting the MU-MIMO function according to a determination result, and the controller further allocating a first transferring time frame to the first group and allocating a second transferring time frame to the second group according to the data transfer requests, the controller controlling the transceiver to transfer data requested by the second group within the second transferring time frame; and
a MU-MIMO module coupled to the controller, wherein the controller controls the MU-MIMO module to transfer data requested by the first group within the first transferring time frame.

8. The wireless access point of claim 7, wherein the first transferring time frame comprise at least one first transferring time slot.

9. The wireless access point of claim 8, wherein the controller further determines a data transfer order of the first group and the second group.

10. The wireless access point of claim 9, wherein the controller determines the data transfer order of the first and the second groups according to the time at which the data transfer request from each of the electronic devices is received.

11. The wireless access point of claim 10, wherein the controller determines whether the data requested by the first group is transferred completely, if so, switch to the second transferring time frame.

12. The wireless access point of claim 10, wherein the controller determines whether the data requested by the second group is transferred completely, if so, switch to the first transferring time frame.

13. A computer program product capable of performing a data transfer method after being installed and executed in a wireless access point, the wireless access point supporting a Multi-User Multiple-Input Multiple-Output (MU-MIMO) function, the data transfer method comprising:
receiving support function information and a data transfer request from each of a plurality of electronic devices;
determining whether each of the electronic devices supports the MU-MIMO function according to the support function information;
dividing the electronic devices into a first group supporting the MU-MIMO function and a second group without supporting the MU-MIMO function;
allocating a first transferring time frame to the first group and allocating a second transferring time frame to the second group according to the data transfer requests;
transferring data requested by the first group within the first transferring time frame via the MU-MIMO function; and
transferring data requested by the second group within the second transferring time frame.

14. The computer program product of claim 13, wherein the first transferring time frame comprises at least one first transferring time slot.

15. The computer program product of claim 14 further comprising determining a data transfer order of the first group and the second group.

16. The computer program product of claim 15, wherein determining the data transfer order of the first group and the second group further comprises:
determining the data transfer order of the first group and the second group according to the time at which the data transfer request from each of the electronic devices is received.

17. The computer program product of claim 16 further comprising: determining whether the data requested by the first group is transferred completely, if so, switching to the second transferring time frame.

18. The computer program product of claim 16 further comprising: determining whether the data requested by the second group is transferred completely, if so, switching to the first transferring time frame.
